(19) United States
(12) Patent Application Publication
(10) Pub. No.: US 2014/0144268 A1
(43) Pub. Date: May 29, 2014

(54) HYDRODYNAMIC GEAR ASSEMBLY

(71) Applicant: Lyle Ward, Rockford, IL (US)

(72) Inventor: Lyle Ward, Rockford, IL (US)

(21) Appl. No.: 13/686,407

(22) Filed: Nov. 27, 2012

(51) Int. Cl. F16H 57/022; F16H 57/023

(52) U.S. Cl. CPC F16H 57/022; F16H 57/023
USPC 74/397; 29/893.1

(57) ABSTRACT

A gear assembly includes a first gear having a first pitch diameter and a second gear having a second pitch diameter different than the first pitch diameter. The first and second gears are located in a housing bore having a cusp line between first and second sections of the housing bore corresponding to the first and second gears. A first gear bearing is located in the first section of the housing bore and has a first flat side. A second gear bearing is located in the second section of the housing bore and has a second flat side. The second flat side is configured to press against the first flat side along the cusp line of the gear housing based on a pressurized fluid being provided to the housing bore.

### BACKGROUND OF THE INVENTION

Conventional gear assemblies, such as a gear assembly for an aircraft turbine engine main fuel pump, have drive gears and driven gears having the same tooth count, pitch diameters and other gear parameters. The drive and driven gears may have positions that are fixed with respect to each other in a gear housing bore by bearings. The bearings may have a flat side configured to contact a flat side of a mating bearing. For example, the flat side of the drive gear bearing may contact the flat side of the driven gear bearing to maintain the drive gear and driven gear a fixed distance apart from each other, and at substantially fixed positions within the gear housing bore. In conventional gear assemblies in which the drive gear and driven gear have the same tooth count, pitch diameters and other gear parameters, the gear bearings may be configured such that the flat portions of the gear bearings correspond to a common pitch line of the mated gears. As understood by those of skill in the art, the pitch line refers to a line in a toothed gear, located at an approximate center of the tooth height of the gear, such that the gear and a mated gear have a common velocity in rolling contact at the pitch line.

Although locating the flat portion of the gear bearings at a shared pitch line between two gears having the same gear parameters results in a small cusp leakage area, some gear assemblies require mated gears having different parameters, such as a different number of teeth, different pitch diameters, etc.

### BRIEF DESCRIPTION OF THE INVENTION

Embodiments of the present invention relate to a gear assembly. The gear assembly includes a first gear having a first pitch diameter and a second gear having a second pitch diameter different than the first pitch diameter. A gear housing has a housing bore, and the housing bore has a first section shaped to accommodate the first gear and a second section shaped to accommodate the second gear. The first and second sections narrow to a cusp line defining a line where the first section adjoins the second section. A first gear bearing is located in the first section of the housing bore and has a first flat side. The first gear is rotatable with respect to the first gear bearing. A second gear bearing is located in the second section of the housing bore and has a second flat side. The second gear is rotatable with respect to the second gear bearing. The second flat side is configured to press against the first flat side along the cusp line of the gear housing based on a pressurized fluid being provided to the housing bore.

Additional embodiments of the present invention relate to a method of fabricating a gear assembly. The method includes determining a cusp line of a gear housing bore corresponding to a location at which a first section having a first diameter adjoins a second section having a second diameter. The first and second sections are shaped to accommodate a first gear and a second gear, respectively. The method includes providing a first gear unit in the first section and a second gear unit in the second section. The first gear unit includes the first gear and a first gear bearing and the second gear unit includes the second gear and a second gear bearing. The first gear bearing has a first flat portion and the second gear bearing has a second flat portion. The method includes providing a pressurized fluid into the gear housing bore to press the first flat side against the second flat side along the cusp line of the gear housing bore.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a gear assembly according to one embodiment of the invention;

FIG. 2 illustrates a gear unit according to one embodiment;

FIG. 3 illustrates another gear unit according to one embodiment;

FIG. 4 illustrates a gear assembly according to another embodiment of the invention;

FIG. 5 illustrates a gear unit according to one embodiment;

FIG. 6 illustrates another gear unit according to one embodiment; and

FIG. 7 illustrates a flow diagram of a method for fabricating a gear assembly according to an embodiment of the invention.

### DETAILED DESCRIPTION OF THE INVENTION

In conventional gear pump systems, gears have the same dimensions, so that the gears are driven at the same rotation rate. Embodiments of the present invention relate to a gear pump configuration in which gear bearings are provided improve operation of the gear pump by reducing a cusp leakage area.

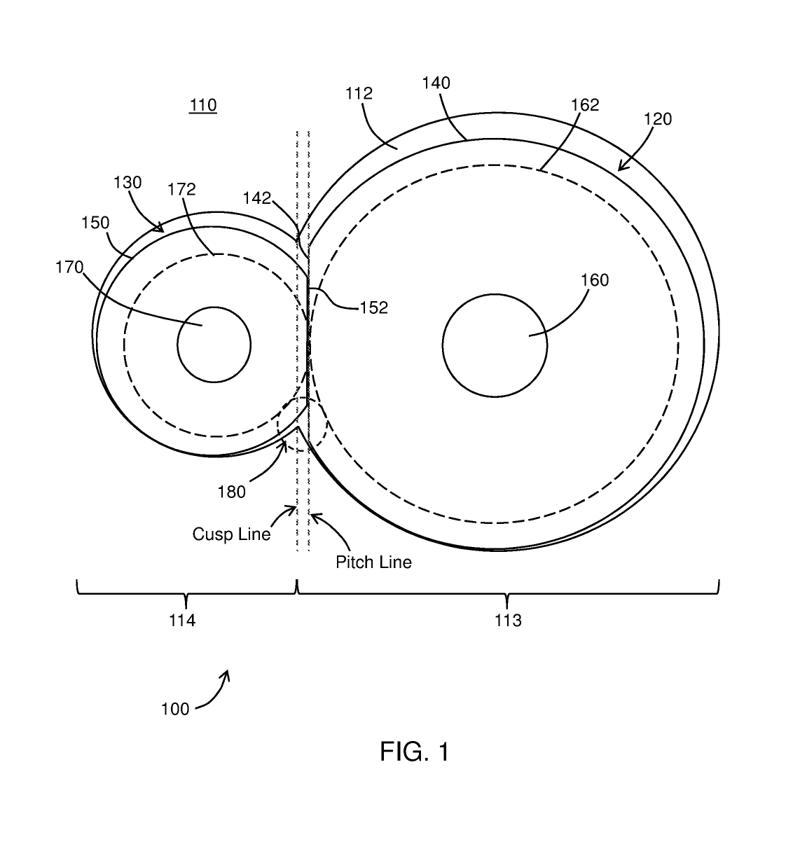

FIG. 1 illustrates a gear assembly 100 having gear units 120 and 130 with different dimensions, such as different tooth counts or different pitch diameters. The gear assembly 100 includes a gear housing 110 defining a gear housing bore 112. The gear housing bore 112 includes a first portion 113, also referred to as a first section 113, shaped to accommodate the first gear unit 120 and a second portion 114, also referred to as a second section 114, configured to accommodate the second gear unit 130. In particular, in an embodiment in which the first and second gear units 120 and 130 are substantially cylindrically-shaped, the first and second portions 113 and 114 of the gear housing bore 112 are also substantially cylindrically-shaped, having diameters larger than the diameters of the first and second gear units 120 and 130 to accommodate the first and second gear units 120 and 130.

The first gear unit 120 and second gear unit 130 are configured to rotate around a first shaft 160 and second shaft 170. The gear assembly 100 also includes a first gear bearing 140 and a second gear bearing 150. The first gear bearing 140 includes a flat side 142 and the second gear bearing 150 includes a flat side 152. The flat side 142 of the first gear bearing 140 is configured to be positioned against the flat side 152 of the second gear bearing 150. The flat sides 142 and 152 of the first and second gear bearings 140 and 150 maintain the gears 120 and 130 at predetermined positions within the gear housing bore 112.

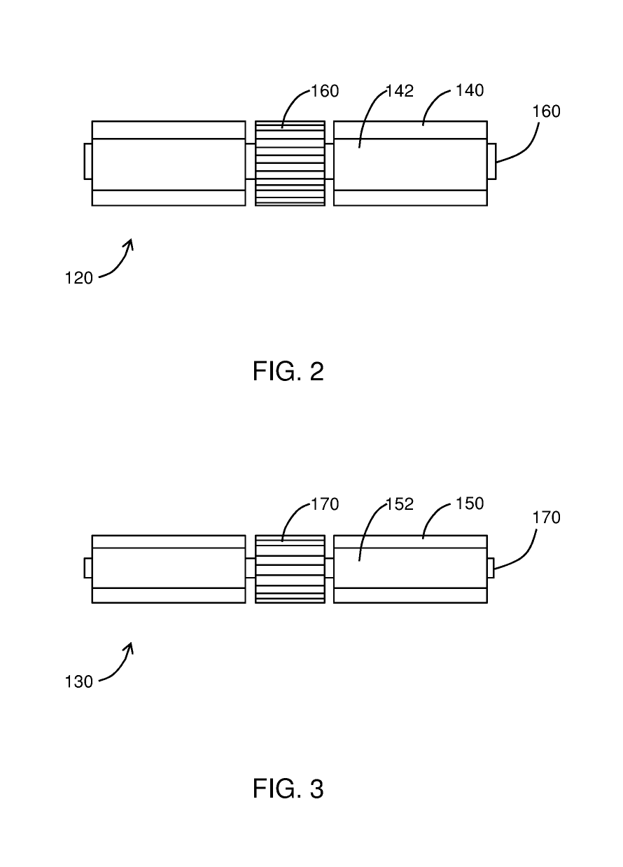

FIGS. 2 and 3 illustrate another side view of the first gear unit 120 and the second gear unit, respectively. Referring to FIG. 2, the first gear unit 120 includes gear bearings 140 positioned on each side of the gear 160. The gear 160 may be fixed with respect to the shaft 160 and the shaft may rotate within the gear bearings 140. Referring to FIG. 3, the second gear unit 130 includes gear bearings 150 on each side of the gear 170.

Referring to FIGS. 1-3, a pitch diameter 162 and 172 of the first and second gears 160 and 170, respectively, are represented by dashed lines. The pitch diameter 162 of the first gear 160 contacts the pitch diameter 172 of the second gear 170 at a point defining the pitch line. A line where the first portion 113 of the gear bore adjoins the second portion 114 defines a cusp line. In other words, the cusp line (in a cross-sectional view) or a cusp plane (in a 3-dimensional view) corresponds to the line or plane where the substantially cylindrical shape of the first portion 113 of the gear housing bore 112 adjoins the second portion 114 of the gear housing bore 112, and may be the narrowest point in a region where the first portion 113 joins the second portion 114.

In the gear assembly 100 illustrated in FIGS. 1-3, the first and second gears 160 and 170 have pitch diameters 162 and 172 of different sizes, such that a location of the pitch line is not co-linear with the location of the cusp line. In addition, the flat sides 142 and 152 of the first and second gear bearings 140 and 150 are positioned to correspond to a location of the shared pitch line of the first and second gears 160 and 170. However, aligning the flat sides 142 and 152 with the pitch line results in a leakage area 180 from which a fluid could escape the gear housing bore 112.

In operation of the gear assembly 100, a fluid is provided into the gear housing bore 112. Referring to FIG. 1, a bottom portion of the housing bore 112, where the gear bearings 140 and 150 are illustrated as being in contact with a wall of the gear housing 110 may correspond to an a fluid inlet side and an upper portion of the gear housing bore 112, where a space is illustrated between the gear bearings 140 and 150 and a wall of the gear housing 110 may correspond to a fluid outlet side. The fluid may have a high pressure, such that the fluid presses the gear units 120 and 130 against each other, and the gears 160 and 170 engage each other. While FIGS. 1-3 illustrate a space between the gear bearings 140 and 150 and the wall of the gear housing bore 112, the drawings are provided for purposes of illustration and may not be drawn to scale. For example, a space between the gear bearing 140 and a wall of the gear housing bore 112 on an upper portion of the gear bearing wall may have a width measured in one or more micrometers, less than a millimeter, in an embodiment in which the gear bearing 140 has a diameter measured in one or more centimeters.

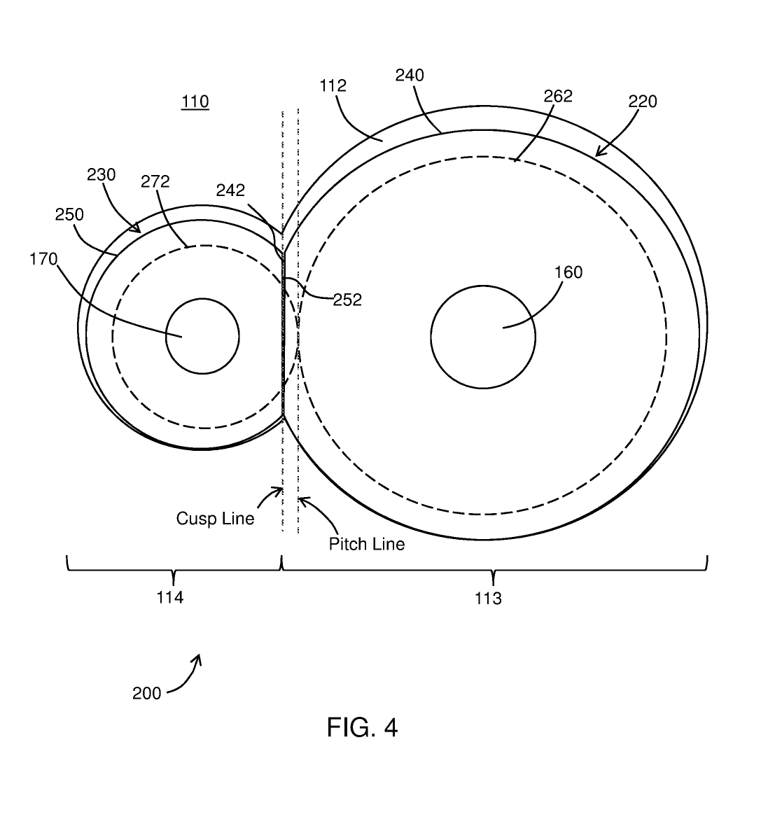

FIG. 4 illustrates a gear assembly 200 according to an embodiment of the present invention. The gear assembly 200 includes a gear housing 110 defining a gear housing bore 112, a first gear unit 220 and a second gear unit 230. The gear housing bore 112 includes a first portion 113, also referred to as a first section 113, shaped to accommodate the first gear unit 220 and a second portion 114, also referred to as a second section 114, configured to accommodate the second gear unit 230. In particular, in an embodiment in which the first and second gear units 220 and 230 are substantially cylindrically-shaped, the first and second portions 113 and 114 of the gear housing bore 112 are also substantially cylindrically-shaped, having diameters larger than the diameters of the first and second gear units 220 and 230 to accommodate the first and second gear units 220 and 230.

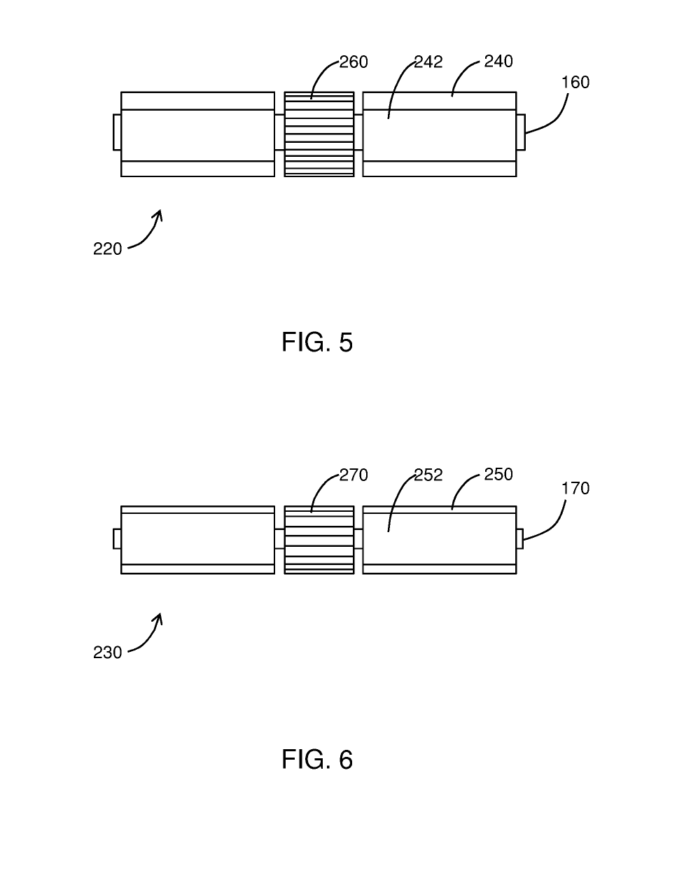

FIGS. 5 and 6 illustrate side views of the first and second gear units 220 and 230, respectively. As illustrated in FIG. 5, the first gear unit 220 includes a shaft 160, first gear bearings 240 and a first gear 260 positioned between the first gear bearings 240. An outer diameter of the first gear 260 may be substantially the same as, or only slightly smaller than, the outer diameter of the first gear bearing 240. For example, the outer diameter of the first gear 260 may be a fraction of a percent (such as around 0.1 percent) smaller than an outer diameter of the first gear bearing 240. The first gear bearing 240 includes a flat side 242, described in further detail below.

Referring to FIG. 6, the second gear unit 230 includes a shaft 170, second gear bearings 250 and a second gear 270 positioned between the second gear bearings 250. An outer diameter of the second gear 270 may be substantially the same as, or only slightly smaller than, the outer diameter of the second gear bearing 250. For example, the outer diameter of the second gear 270 may be a fraction of a percent (such as around 0.1 percent) smaller than an outer diameter of the second gear bearing 250. The second gear bearing 250 includes a flat side 252, described in further detail below.

Referring to FIGS. 4-6, the first gear 260 and the second gear 270 have different gear parameters. For example, the first gear 260 may have one or more of a different tooth count, pitch diameter, or gear outer diameter than the second gear 270. The first gear 260 and second gear 270 are configured to rotate around a first shaft 160 and second shaft 170. The flat side 242 of the first gear bearing 240 is configured to be positioned against the flat side 252 of the second gear bearing 250. The flat sides 242 and 252 of the first and second gear bearings 240 and 250 maintain the gears 260 and 270 at predetermined positions within the gear housing bore 112. In one embodiment, the flat sides 242 and 252 of the first and second gear bearings 240 and 250 have the same dimensions, such as a same height and a same width, and are configured to substantially align with each other. In other words, a bottom edge, a top edge and side edges of the flat side 242 may align with the bottom edge of the flat side 252.

In FIGS. 4-6, a pitch diameter 262 and 272 of the first and second gears 260 and 270, respectively, are represented by dashed lines. The pitch diameter 262 of the first gear 260 contacts the pitch diameter 272 of the second gear 270 at a point defining the pitch line. A line where the first portion 113 of the gear bore adjoins the second portion 114 defines a cusp line. In other words, the cusp line (in a cross-sectional view) or a cusp plane (in a 3-dimensional view) corresponds to the line or plane where the substantially cylindrical shape of the first portion 113 of the gear housing bore 112 adjoins the second portion 114 of the gear housing bore 112, and may be the narrowest point in a region where the first portion 113 joins the second portion 114.

In the gear assembly 200 illustrated in FIGS. 4-6, the first and second gears 260 and 270 have pitch diameters 262 and 272 of different sizes, such that a location of the pitch line is not co-linear with the location of the cusp line. In one embodiment of the invention, the flat sides 242 and 252 of the first and second gear bearings 240 and 250 are positioned to correspond to a location of the cusp line of the housing 110 during operation of the gear assembly 200. As illustrated in FIG. 4, when the flat sides 242 and 252 are aligned with the cusp line of the gear housing 110, a space between the gear bearings 240 and 250 and the wall of the gear housing bore 112 is reduced in a region around the cusp line on a lower side of the bearing housing 110, resulting in a reduced leakage area.

The first and second gear bearings 240 and 250 may be configured to have a substantially circular side cross-sectional shape corresponding to an outer diameter of the first and second gears 260 and 270 as defined by outer edges of the teeth of the first and second gears 260 and 270. The flat portions 242 and 252 of the first and second gears 240 and 250 may be tangential cuts in the circular portions, or sides formed by omitting an arc segment from a portion of the circular cross-sectional shape of each of the first and second gear bearings 240 and 250.

In one embodiment, a length of the flat side 242 of the first gear bearing 240 is the same as the length of the flat side 252 of the second gear bearing 250. In embodiments of the invention, the first and second gear bearings 240 and 250 are configured such that the flat side 242 of the first gear bearing 240 crosses over the pitch diameter 272, or is located between the pitch diameter 272 and the shaft 170, of the second gear unit 230.

In operation of the gear assembly 200, a fluid is provided into the gear housing bore 112. Referring to FIG. 4, a bottom portion of the housing bore 112, where the gear bearings 240 and 250 are illustrated as being in contact with a wall of the gear housing 110, may correspond to an a fluid inlet side. In addition, an upper portion of the gear housing bore 112, where a space is illustrated between the gear bearings 240 and 250 and a wall of the gear housing 110 may correspond to a fluid outlet side. The fluid may have a high pressure, such that the fluid presses the gear units 220 and 230 against each other, and the gears 260 and 270 engage each other. The fluid pressure maintains a load within the housing bore 112 that maintains the flat portions 242 and 252 pressed against each other and the gears 260 and 270 pressed against each other. In particular, the pressure results in a load vector of approximately 45 degrees below a horizontal line passing through the first shaft 160 and toward the pitch line. In addition, the pressure results in a load vector of approximately 45 degrees below a horizontal line passing through the shaft 170 and toward the pitch line.

While FIGS. 4-6 illustrate a space between the gear bearings 240 and 250 and the wall of the gear housing bore 112, the drawings are provided for purposes of illustration and may not be drawn to scale. For example, a space between the gear bearing 240 and a wall of the gear housing bore 112 on an upper portion of the gear bearing wall may have a width measured in one or more micrometers, less than a millimeter, in an embodiment in which the gear bearing 240 has a diameter measured in one or more centimeters and the bottom surface of the gear bearing 240 is in contact with the wall of the gear housing bore 112.

In one embodiment, the first and second flat sides 242 and 252 are separable from each other within predefined tolerable distances defined by the sizes of the gear bearings 240 and 250 and the housing bore 112 when no fluid exists in the housing bore 112. In another embodiment, the first and second gear bearings 240 and 250 may be bonded to each other, such as by welding, adhesive, or any other binding mechanism.

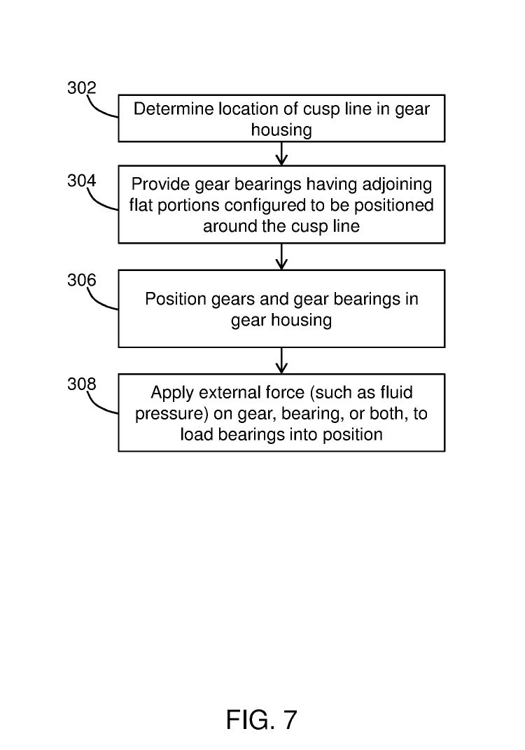

FIG. 7 illustrates a method of fabricating a gear assembly according to an embodiment of the invention. In block 302, a location of the cusp line in a gear housing is determined The cusp line corresponds to a line defining a division between different gear sections of a gear housing. In block 304, gear bearings are provided having flat sides that are configured to be in contact with each other at the cusp line of the gear housing when a load is provided in the gear housing. In one embodiment, the gear bearings are configured to have flat sides that are a same size.

In block 306, gears are positioned within the housing bore and the gear bearings are attached to the gears to maintain the gears at predetermined positions within the housing bore, with flat sides of the gear bearings being positioned to be facing each other at the cusp line of the gear housing. In block 308, a force is applied to the gears, to the gear bearings, or to each of the gears and gear bearings, to load the gear bearings into position, where the flat sides are in contact with each other and the teeth of the gears are engaged with each other. In one embodiment, a pressurized fluid is introduced into the gear housing to load the gear assembly, pressing the gear bearings against each other and engaging the gears with each other. In embodiments of the invention, when the force is applied to one or both of the gears and gear bearings, the flat sides of the gear bearings come into contact with each other at the cusp line of the gear housing and are maintained in contact while the force is maintained. In embodiments of the invention, the force, such as a fluid pressure, presses the gear bearings against one side of the gear housing, and the alignment of the flat sides of the gear bearings with the cusp line results in a reduced or eliminated cusp leakage area around the cusp line.

A gear assembly according to embodiments of the present invention may have any size. In one embodiment, an outer diameter of the gears and gear bearings is around 5 centimeters (cm) and an inner diameter of the gear bearings is around 2.5 cm. In one embodiment, an axial length of the gear units (including the gear bearings positioned on each side of the gear) is around 3-5 cm. Although a few examples are provided by way of description, embodiments of the invention encompass gear assemblies of any size. In some embodiments, the gear assembly is a hydrodynamic gear assembly configured to rotation within a fluid environment, such as oil inside the gear housing bore. A gear assembly according to embodiments of the present invention may be used in gear pumps, such as gear pumps of aircraft turbine engines. Gear assemblies according to embodiments of the present invention may also be used in any other type of vehicle or any type of stationary structures and system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A gear assembly, comprising:
a first gear having a first pitch diameter;
a second gear having a second pitch diameter different than the first pitch diameter;
a gear housing having a housing bore, the housing bore having a first section shaped to accommodate the first gear and a second section shaped to accommodate the second gear, the first and second sections narrowing to a cusp line defining a line where the first section adjoins the second section;
a first gear bearing located in the first section of the housing bore and having a first flat side, the first gear being rotatable with respect to the first gear bearing; and
a second gear bearing located in the second section of the housing bore and having a second flat side, the second gear being rotatable with respect to the second gear bearing, the second flat side configured to press against the first flat side along the cusp line of the gear housing based on a pressurized fluid being provided to the housing bore.

2. The gear assembly of claim 1, wherein the first flat side and the second flat side are configured such that the first gear and the second gear are engaged with each other when the first flat side presses against the second flat side.

3. The gear assembly of claim 2, wherein the first pitch diameter tangentially contacts the second pitch diameter when the first flat side presses against the second flat side.

4. The gear assembly of claim 1, wherein the first and second flat sides are located in the first section of the gear housing bore.

5. The gear assembly of claim 1, wherein the first and second flat sides have a same length along the cusp line.

6. The gear assembly of claim 1, wherein the first gear bearing has substantially a same cross-sectional diameter as the first gear.

7. The gear assembly of claim 1, wherein the first gear bearing has an inner diameter configured to receive a shaft, and the first gear rotates with respect to the first gear bearing based on a rotation of the shaft.

8. The gear assembly of claim 1, wherein the first and second gear bearings have a cross-sectional shape of a circle having an arc segment omitted to form the first and second flat sides.

9. The gear assembly of claim 1, wherein the first gear bearing has a substantially cylindrical shape having a cylinder segment omitted to form the first flat side.

10. A method of fabricating a gear assembly, comprising:
determining a cusp line of a gear housing bore corresponding to a location at which a first section having a first diameter adjoins a second section having a second diameter, the first and second sections shaped to accommodate a first gear and a second gear, respectively;
providing a first gear unit in the first section and a second gear unit in the second section, the first gear unit including the first gear and a first gear bearing, the second gear unit including the second gear and a second gear bearing, the first gear bearing having a first flat portion and the second gear bearing having a second flat portion; and
providing a pressurized fluid into the gear housing bore to press the first flat side against the second flat side along the cusp line of the gear housing bore.

11. The method of claim 10, wherein the first flat side and the second flat side are configured such that the first gear and the second gear are engaged with each other when the first flat side presses against the second flat side.

12. The method of claim 10, wherein the first gear has a first pitch diameter, the second gear has a second pitch diameter, and the first pitch diameter is different than the second pitch diameter, and
the first pitch diameter tangentially contacts the second pitch diameter when the first flat side presses against the second flat side.

13. The method of claim 12, wherein the first and second flat sides are located in the second section of the gear housing bore.

14. The method of claim 10, wherein the first and second flat sides have a same length along the cusp line.

15. The method of claim 10, wherein the first gear bearing has an inner diameter configured to receive a shaft, and the first gear rotates with respect to the first gear bearing based on a rotation of the shaft.

16. The method of claim 10, wherein the first gear bearing has a substantially cylindrical shape having a cylinder segment omitted to form the first flat side.
